(19) United States
(12) Patent Application Publication
(10) Pub. No.: US 2020/0041720 A1
(43) Pub. Date: Feb. 6, 2020

(54) CONFIGURABLE DISPLAY WITH TAPERED FIBER OPTIC BUNDLE

(71) Applicant: Continental Automotive Systems, Inc., Auburn Hills, MI (US)

(72) Inventors: Irving Morales Rodriguez, Guadalajara (MX); Enrique Chavez Luna, Guadalajara (MX); Hermes Ivan Rodriguez-Apodaca, Guadalajara (MX)

(21) Appl. No.: 16/527,283

(22) Filed: Jul. 31, 2019

Related U.S. Application Data
(60) Provisional application No. 62/712,497, filed on Jul. 31, 2018.

(51) Int. Cl. G02B 6/06; B60K 35/00; B64D 43/00

(52) U.S. Cl. CPC G02B 6/06; B64D 43/00; B60K 35/00

(57) ABSTRACT

Image information from a region of a rectangular flat-panel device is made to appear round or nearly round by routing light from a region of the flat panel display device into the narrow end of a bundle of tapered fiber optic cables. Each cable in the bundle is tapered over its length. The taper effectively causes an image input into the narrow end to be enlarged or magnified at the opposing wider end.

### CROSS REFERENCE TO RELATED APPLICATIONS

U.S. patent application claims the benefit of U.S. provisional patent application No. 62/712,497, filed Jul. 31, 2018 which is hereby incorporated by reference.

### BACKGROUND

Instrument panels in motor vehicles typically use round or near-round dials and gauges. Rectangular display devices, however, are common and quite inexpensive but they are rarely used as a gauge or dial in a motor vehicle instrument panel mainly because of subjective styling preferences. An apparatus that can obtain graphical, image information from at least a portion of a rectangular display device and economically and reliably provide at least some of that graphic information in a larger, round or near-round dial or gauge, would be an improvement over the prior art.

### SUMMARY

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification. It should be understood that the detailed description and specific examples, while indicating the preferred embodiment of the disclosure, are intended for purposes of illustration only and are not intended to limit the scope of the disclosure.

One general aspect includes a configurable display device including: a housing; a rectangular flat panel display device; a bundle of fiber optic cables including a plurality of tapered fiber optic cables each of which is tapered, the bundle of fiber optic cables having a first round end and a second round end, the second round end having an area that is greater than the area of the first round end; and where a portion of an image on the rectangular flat panel display device that is input to the first round end is enlarged and displayed on each of the plurality of tapered fiber optic cables at the second round end. Implementations may include one or more of the following features. The configurable display device further including a truncated cone where the bundle of fiber optic cables are held together.

The configurable display device where the image displayed on each of the plurality of tapered fiber optic cables at the second round end of the truncated cone is formed in shape corresponding to a cross-sectional shape of the truncated cone.

The configurable display device where a cross-sectional shape of the truncated cone is one of round, oval, star-shaped, and polygonal other than square.

The configurable display device where the first and second round ends are substantially planar.

The configurable display device where the bundle of fiber optic cables includes the plurality of fiber tapered optic cables having different lengths.

The configurable display device where the lengths of the tapered fiber optic cables near a center of the bundle of fiber optic cables are shorter than the lengths of the tapered fiber optic cables near an exterior of the bundle of fiber optic cables.

The configurable display device where the display device is an instrument gauge for an automotive vehicle, or an aircraft.

Another general aspect includes a configurable display including: a housing; a rectangular flat panel display device; a bundle of fiber optic cables including a plurality of tapered fiber optic cables each of which is tapered, the bundle of fiber optic cables having a first round end and a second round end, the second round end having an area that is greater than the area of the first round end; where a portion of an image on the rectangular flat panel display device that is input to the first round end is enlarged and displayed on each of the plurality of tapered fiber optic cables at the second round end; and a truncated cone where the bundle of fiber optic cables are held together, where the image displayed on each of the plurality of tapered fiber optic cables at the second end of the truncated cone is formed in a cross-sectional shape of the truncated cone.

Implementations may include one or more of the following features. The configurable display where the cross-sectional shape of the truncated cone is one of round, oval, star-shaped, and polygonal other than square.

The configurable display where the first and second round ends are substantially planar.

The configurable display where the bundle of fiber optic cables includes a plurality of cables having different lengths.

The configurable display where the lengths of the plurality of tapered fiber optic cables near a center of the bundle of fiber optic cables are shorter than the lengths of the plurality of tapered fiber optic cables near an exterior of the bundle of fiber optic cables.

The configurable display where the display is an instrument gauge for an automotive vehicle, or an aircraft.

One general aspect includes a method of providing a shape configurable display including: providing an image on a rectangular flat panel display device; inputting the image on the flat panel display into a first round end of a plurality of fiber optic cables each of which is tapered such that, a second round end of the plurality of fiber optic cables has an area that is greater than the area of the first round end; displaying a portion of an image on the rectangular flat panel display device that is input to the first round end at the second round end each of the plurality of fiber optic cables; and retaining the plurality of fiber optic cables together with a truncated cone to form a bundle of fiber optic cables.

Implementations may include one or more of the following features. The method of displaying an image for an instrument gauge for an automotive vehicle, or an aircraft.

The method, wherein the image displayed on the individual fibers at the second end of the cone is formed in the cross-sectional shape of the truncated cone.

The method, wherein the cross-sectional shape of the truncated cone is one of round, oval, star-shaped, and polygonal other than square.

The method, wherein the first and second round ends are substantially planar.

The method, wherein the bundle of tapered fiber optic cable comprises a plurality of cables having different lengths.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification. It should be understood that the detailed description and specific examples, while indicating the preferred embodiment of the disclosure, are intended for purposes of illustration only and are not intended to limit the scope of the disclosure.

### BRIEF DESCRIPTION OF THE FIGURES

FIG. 1 is an exploded-view of a configurable display using a tapered optic fiber bundle;

FIG. 2 is a perspective view of a length of a single fiber optic cable, smoothly and uniformly tapered between first and second opposing ends;

FIG. 3 is a perspective view of a bundle of tapered fiber optic cables; and

FIG. 4 is a schematic view of an exemplary method for providing a configurable display.

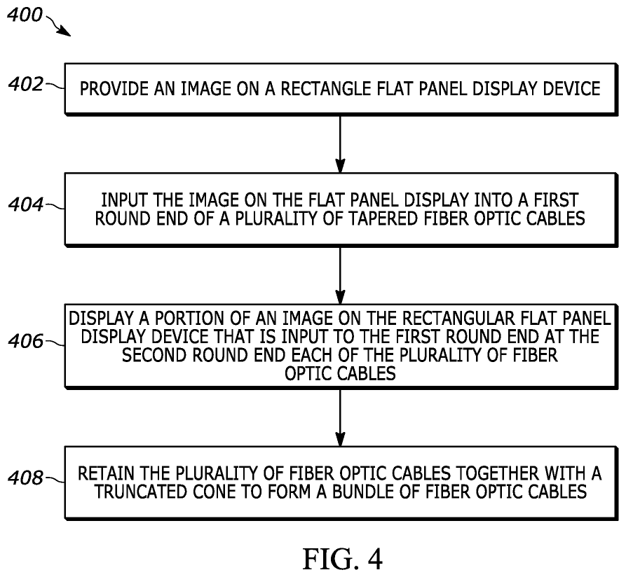

### DETAILED DESCRIPTION

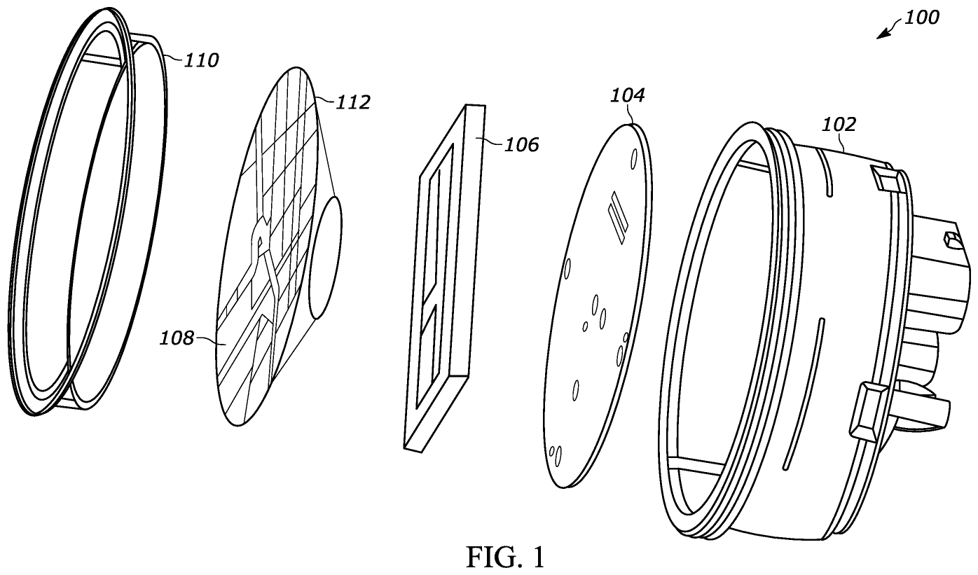

FIG. 1 is an exploded view of a configurable display 100 for a motor vehicle instrument panel, which uses a bundle 112 of tapered optic fiber cables 108. The display 100 comprises a substantially cylindrical housing 102, into which is assembled a conventional circuit board 104 attached to which is a conventional rectangular flat panel display device 106. Signals on the circuit board 104 are electrically coupled into the display device 106, which cause an image to be generated on the display device 106.

Rectangular flat panel display devices, whether they are made of LEDs, liquid crystal or other technologies are well known. Their rectangular shape, however, is not preferred in motor vehicle instrument panel applications nor are they preferred in some aircraft instrument panel.

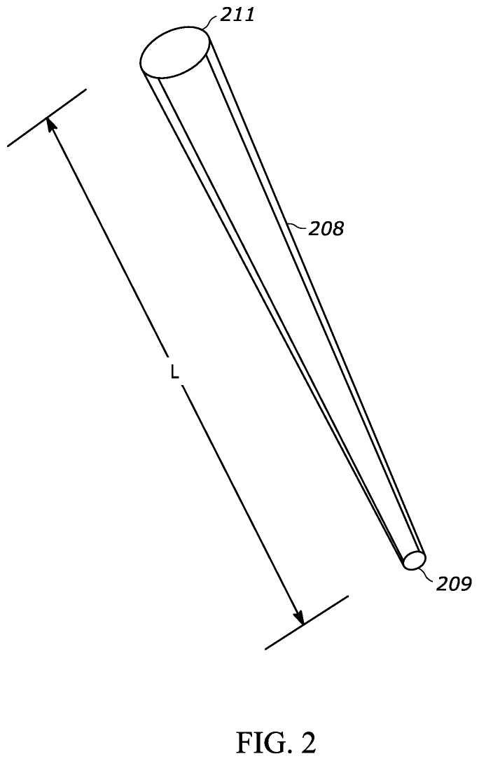

In FIG. 1, a substantially round or near-round portion of the image displayed on the rectangular flat panel display 106 is “copied into” one end, i.e., a narrow end 109, of a bundle 112 of tapered fiber optic cables, one of which is shown in FIG. 2. The image copied into the narrow end 109 is effectively “converted” by the tapered fiber optic cables to form at a second end 111, a larger or magnified copy of the image that was input to the narrow end 109. A bezel 110 is mounted over the second or larger end 111 of the tapered fiber optic bundle 112. All of the components depicted in FIG. 1 are assembled into the housing 102.

FIG. 2 is a perspective view of a single tapered fiber optic cable 208 having a length, L, between a first narrow end 209 and an enlarged or widened end 211. The tapered fiber optic cable 208 enables a portion of an image entering the narrow end 209 to be broadened or widened as it travels down the length of the taper and is displayed at the wide end 211. By forming an essentially funnel-shaped bundle of such fibers, a portion of an image displayed on a flat panel display device can be magnified and displayed on a round or nearly round “fiber optic display device,” i.e., a display device comprising numerous, tapered fiber optic cables.

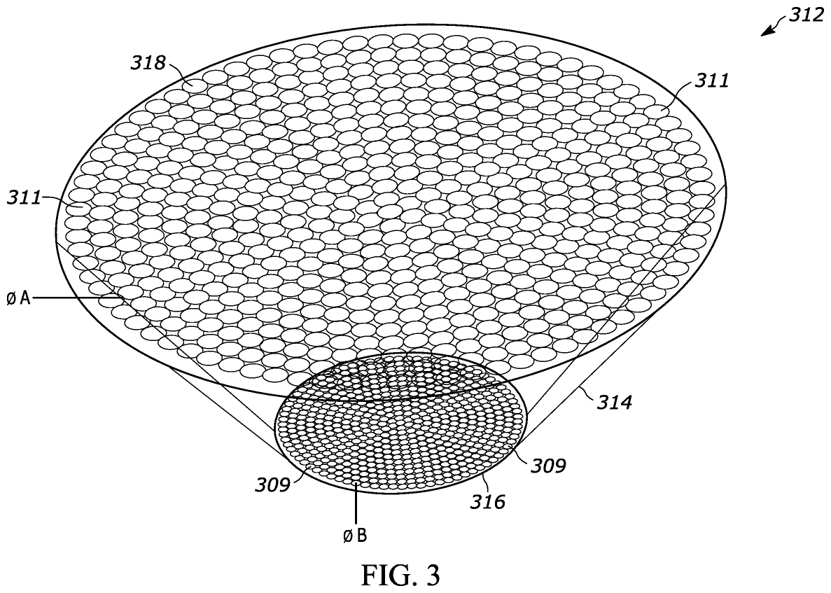

FIG. 3 is a perspective view of a tapered optic fiber bundle 312, usable in the assembly shown in FIG. 1. For the sake of clarity, the tapered fiber optic bundle 312 shown in FIG. 3 is described without reference to FIG. 1.

The bundle 312 comprises numerous fiber optic cables 308, which are tapered along the length of each cable between each cable's first and second opposing ends 309, 311. The bundle 312 can be formed by inserting tapered fiber optic cables into a light weight, rigid or semi-rigid truncated cone or funnel 314 and using an appropriate adhesive on the exterior surface of the cables to hold them in place, in the funnel. The funnel having a narrow first end 316 and tapering outward to a wider second end 318. The rate of tapering of the funnel 314 corresponds to the rate of tapering on the fiber optic cables 308, such that the first ends 309 of the cable fit within the first end 316 of the funnel 314 and the second ends 311 of the fiber optic cables 308 fit within the second end 318 of the funnel 314.

When several tapered fiber optic cables are bundled together, they form what is essentially a truncated, cone-shaped assembly 312 of such fiber optic cables having opposing first and second ends, 316 and 318 respectively. The lower or first end 309 is comprised of the first or smaller-diameter end of numerous tapered fiber optic cables and is thus narrower in diameter than the top or upper end 311. The upper ends 311 of the fiber optic cables in the bundle 312, provide an enlarged copy of image information input to each fiber optic cable at the bottom or lower end 309. Both ends of the bundle 312 are preferably flat or planar.

By locating the lower or narrow end of a bundle of tapered fiberoptic cables against a region of a conventional flat panel display, such as the one identified in FIG. 1 by reference numeral 106, the size and shape of the information displayed on the flat panel display 106 can be changed to appear to be from a circular or round display, such as those used in prior art instrument panels.

Alternatively, the cross-section of the cone or funnel 314 is provided with a specific shape for the desired shape of the image to be displayed. For example, if a star-shaped image, or other polygonal shaped image is desired the cross-sectional shape of the funnel 314 will reflect the desired shape of the image. The shapes listed here are merely suggestions. One skilled in the art would be able to determine other image-shapes that could be desired and how to retain the second ends 311 of the bundle 312 in such a manner to create the desired shape.

Those of ordinary skill should recognize that the apparatus described herein could be used with any type of flat panel display device, examples of which include LED and liquid crystal displays.

Those of ordinary should also recognize that fiber optic cables near the center of the truncated cone shown in FIG. 3 will be shorter than cables at the exterior of the truncated cone. The opposing ends 309, 311 can be flattened or made planar by cutting the ends of the cables at the top and bottom of the funnel 314 in which they are held.

The tapered fiber optic cable could be made of any suitable light-transmissive material including glass, quartz and plastic.

For claim construction purposes, the term “round” should be construed to include round as well as near-round or oval.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the scope of the following claims.

What is claimed is:

1. A configurable display device comprising:
a housing;
a rectangular flat panel display device;
a bundle of fiber optic cables comprising a plurality of tapered fiber optic cables each of which is tapered, the bundle of fiber optic cables having a first round end and a second round end, the second round end having an area that is greater than the area of the first round end; and
whereby a portion of an image on the rectangular flat panel display device that is input to the first round end is enlarged and displayed on each of the plurality of tapered fiber optic cables at the second round end.

2. The configurable display device of claim 1, further comprising a truncated cone wherein the bundle of fiber optic cables are held together.

3. The configurable display device of claim 2, wherein the image displayed on each of the plurality of tapered fiber optic cables at the second round end of the truncated cone is formed in shape corresponding to a cross-sectional shape of the truncated cone.

4. The configurable display device of claim 2, wherein a cross-sectional shape of the truncated cone is one of round, oval, star-shaped, and polygonal other than square.

5. The configurable display device of claim 1, wherein the first and second round ends are substantially planar.

6. The configurable display device of claim 1, wherein the bundle of fiber optic cables comprises the plurality of fiber tapered optic cables having different lengths.

7. The configurable display device of claim 1, wherein the lengths of the tapered fiber optic cables near a center of the bundle of fiber optic cables are shorter than the lengths of the tapered fiber optic cables near an exterior of the bundle of fiber optic cables.

8. The configurable display device of claim 1, wherein the display device is an instrument gauge for an automotive vehicle, or an aircraft.

9. A configurable display comprising:
a housing;
a rectangular flat panel display device;
a bundle of fiber optic cables comprising a plurality of tapered fiber optic cables each of which is tapered, the bundle of fiber optic cables having a first round end and a second round end, the second round end having an area that is greater than the area of the first round end;
whereby a portion of an image on the rectangular flat panel display device that is input to the first round end is enlarged and displayed on each of the plurality of tapered fiber optic cables at the second round end; and
a truncated cone wherein the bundle of fiber optic cables are held together, wherein the image displayed on each of the plurality of tapered fiber optic cables at the second end of the truncated cone is formed in a cross-sectional shape of the truncated cone.

10. The configurable display of claim 9, wherein the cross-sectional shape of the truncated cone is one of round, oval, star-shaped, and polygonal other than square.

11. The configurable display of claim 9, wherein the first and second round ends are substantially planar.

12. The configurable display of claim 9, wherein the bundle of fiber optic cables comprises a plurality of cables having different lengths.

13. The configurable display of claim 9, wherein the lengths of the plurality of tapered fiber optic cables near a center of the bundle of fiber optic cables are shorter than the lengths of the plurality of tapered fiber optic cables near an exterior of the bundle of fiber optic cables.

14. The configurable display of claim 9, wherein the display is an instrument gauge for an automotive vehicle, or an aircraft.

15. A method of providing a shape configurable display comprising:
providing an image on a rectangular flat panel display device;
inputting the image on the flat panel display into a first round end of a plurality of fiber optic cables each of which is tapered such that, a second round end of the plurality of fiber optic cables has an area that is greater than the area of the first round end;
displaying a portion of an image on the rectangular flat panel display device that is input to the first round end at the second round end each of the plurality of fiber optic cables; and
retaining the plurality of fiber optic cables together with a truncated cone to form a bundle of fiber optic cables.

16. The method of claim 15, further comprising displaying an image for an instrument gauge for an automotive vehicle, or an aircraft.

17. The method of claim 15, wherein the image displayed on the individual fibers at the second end of the cone is formed in the cross-sectional shape of the truncated cone.

18. The method of claim 15, wherein the cross-sectional shape of the truncated cone is one of round, oval, star-shaped, and polygonal other than square.

19. The method of claim 15, wherein the first and second round ends are substantially planar.

20. The method of claim 15, wherein the bundle of tapered fiber optic cable comprises a plurality of cables having different lengths.
